(19) United States
(12) Patent Application Publication
(10) Pub. No.: US 2006/0229999 A1
(43) Pub. Date: Oct. 12, 2006

(54) Decision support system for litigation evaluation

(76) Inventors: Herbert Dodell, Agoura, CA (US); Brenda Pomerance, New York, NY (US)

Correspondence Address: BRENDA POMERANCE;LAW OFFICE OF BRENDA POMERANCE, 260 WEST 52 STREET SUITE 27B, NEW YORK, NY, 10019, US

(21) Appl. No.: 11/103,250

(22) Filed: Apr. 11, 2005

(51) Int. Cl. G06Q 99/00; H04L 9/00; H04K 1/00

(52) U.S. Cl. 705/80

(57) ABSTRACT

Information about a pre-litigation case is received from a claimant. A case score is determined based on the received information, and compared with a predefined threshold. Further processing for the case is selected based on the comparison. The case score is based on a liability score and a damages score, each of which may be computed as a weighted average. The further processing may be determining what additional information should be collected from the claimant; determining what documents should be collected from the claimant; interviewing the claimant; rejecting the case, referring the case to an outside attorney; or accepting the case for further consideration. The received information includes a case type, and documents are prepared based on the received information and predetermined information associated with the case type. The prepared documents may include a Complaint, a discovery request, or a budget and schedule for the case.

### BACKGROUND OF THE INVENTION

The present invention relates to a decision support system, and more particularly, is directed to a system for supporting evaluation of a case for litigation.

JustSys, an Australian company, has developed a program called GetAid that is used by Victoria Legal Aid to assess applicants for legal aid. The assessment involves evaluating the client's financial status and the likelihood that her case will succeed. GetAid cannot reject applicants, but can only approve them; the unapproved applicants are referred to a legal officer for reconsideration. A benefit of this system is that it enables lawyers to spend more of their time representing people rather than processing applications.

GetAid looks back through past cases and draws inferences from them about whether the client has a winnable case. GetAid uses expert system and machine learning in which a system is “tuned” using historical examples to adjust a model so that it produces the correct answer.

However, there is still room to improve the processing associated with a legal case.

### SUMMARY OF THE INVENTION

In accordance with an aspect of this invention, there are provided a method of and a system for deciding how to process a pre-litigation case. Information about the case is received from a claimant. A case score is determined based on the received information, and compared with a predefined threshold. Further processing for the case is selected based on the comparison.

According to a further aspect of the invention, the case score is based on a liability score and a damages score, each of which may be computed as a weighted average. The further processing may be determining what additional information should be collected from the claimant and adjusting the case score based on the additional information collected from the claimant; determining what documents should be collected from the claimant and adjusting the case score based on the documents collected from the claimant; interviewing the claimant and adjusting the case score based on the interview with the claimant; rejecting the case, referring the case to an outside attorney; or accepting the case.

According to a further aspect of the invention, the received information includes a case type, and documents are prepared based on the received information and predetermined information associated with the case type. The prepared documents may include a Complaint, a discovery request, or a budget and schedule for the case.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing case evaluation system 72 and its environment;

FIGS. 2 is a flowchart depicting set-up of case evaluation system 72;

FIGS. 3A-3D are a flowchart depicting operation of case evaluation system 72;

FIGS. 4A-4C are block diagrams illustrating data structures used by case evaluation system 72;

FIGS. 5 and 6 are flowcharts referenced in describing operation of another embodiment of case evaluation system 72; and

FIG. 7 is a flowchart referenced in describing operation of yet another embodiment of case evaluation system 72.

### DETAILED DESCRIPTION

As used herein, “case” means a pre-litigation matter submitted by a claimant for evaluation.

As used herein, “referred to an outside attorney” means “recommended to an outside attorney”.

An attorney typically conducts an in-person interview with a potential litigation client. During the interview, the attorney gathers facts relating to the case and assesses the potential client to determine whether they can work together. Often, an attorney will require evidence such as documents prior to deciding whether to take a case. The attorney's decision is based on objective factors such as amount of damages and the nature of the case, as well as subjective factors such as how strong the case is and whether the client will be a good client and/or witness.

A lawsuit is formally initiated by filing a Complaint in a state or federal court. Most cases involve doing a substantial amount of work prior to filing a Complaint, that is, formally initiating a lawsuit. Much of this work is administrative in nature, such as collecting documents, identifying the facts, potential witnesses, dates and so on. Usually, the administrative work is a prerequisite to the legal analysis, as the analysis is tailored to the facts.

The above-described conventional process for deciding whether to take a case is inefficient for several reasons. First, much of the work is administrative, and it is wasteful of the lawyer's time to have a lawyer doing the administrative work. Second, the attorney might not uncover a factor that makes the case undesirable until having spent considerable time gathering facts, witnesses and researching the basic legal issues, and determining the general value of the case; this, too, is wasteful of the lawyer's time. Third, the decision is highly unstructured, being based on a vaguely-defined or undefined combination of subjective and objective factors.

The present invention provides a process, practiced by an automated system, for gathering information, scoring cases based on their chances of success as to liability and potential damage awards, and automatically preparing papers based on the gathered information. The process may also incorporate legal research. A system according to the present invention functions as a management and decision support tool for pre-litigation activities.

A brief overall description of the system will now be provided, followed by a detailed description of various embodiments of the system.

The system is operative on at least one general purpose computer, and accessed through user terminals connected either locally or via a network. A claimant terminal provides an interface that collects information from a potential client. An administrative terminal provides an interface for an administrator to administer cases submitted by claimants. A referral receiving terminal enables a third party attorney, that is, an outside attorney not affiliated with the operator of the system, to receive cases referred from the system.

Case descriptive information includes liability elements and remedy elements.

Liability elements are factors relating to (i) whether the claimant has established a situation fitting within a predefined legal cause of action, and (ii) whether the defendant has any defenses that enable avoidance of a remedy award.

Remedy elements include damages, injunctions and other remedies, such as destruction of counterfeit items. For brevity, only damages elements will be further discussed. It will be appreciated that the other remedy elements are analyzed similarly.

Damages elements are factors relating to the amount of damages that can be claimed. Depending on the cause of action, the following types of damages may be available: actual, consequential, punitive and/or statutory; additionally, in some cases, attorney's fees are awarded and these are included in the damages analysis. Actual damages can be economic such as loss of business, non-economic such as for pain and suffering, and may encompass past, present and/or future losses.

In a first operational phase referred to as “L1”, the claimant enters liability and damages information about his or her case, and the system computes a first score. The L1 evaluation is completely objective. If the score is below a first threshold, the case is automatically rejected, and a rejection letter is automatically prepared and sent to the claimant.

The score is computed as follows: each of the liability and damages elements is given a weighting, such as a number from 1 to 100. The claimant's information is translated to a score in a range, such as −5 to +5; lack of information corresponds to a 0. Each individual score is multiplied by the appropriate weight, and the weighted individual scores are summed to produce an overall score. The actual details of the scoring procedure are not crucial, the important feature is that individual bits of information are combined in a way that emphasizes important information. Substantial expertise is required to set the scores and weights correctly; the setting may be done by a human, or by a computer based on abstraction from a large number of examples, or by a combination of human and computer interaction.

If the score is high enough, processing proceeds to a second operational phase, referred to as “L2”, in which key documents are collected and administratively verified. In some cases, a junior attorney provides a basic evaluation by inputting altered or additional data. The L2 evaluation is objective and may also be subjective. The system then computes a second score. If the score is below a second threshold, the case is referred to a third party attorney, that is, an outside attorney.

If the score is above the second threshold, processing proceeds to a third operational phase, referred to as “L3”, in which the claimant is interviewed by a senior attorney, and any information gaps are filled or noted. The senior attorney provides an evaluation of the claimant and the gathered facts by inputting altered or additional data. The L3 evaluation is objective and subjective. The system then computes a third score. If the score is below a third threshold, the case is referred to a third party attorney, that is, an outside attorney.

If the score is above the third threshold, the case is accepted for further consideration.

Prior to the system's referring a case to an outside attorney in the second or third operational phases, or accepting the case in the third operational phase, the system generates a case summary comprising an analysis and evaluation, prepares case template papers and generates an activity record for the case. In most instances, the case summary and case template papers are forwarded to the outside attorney.

The present process for deciding whether to take a case is efficient in several ways. First, there is a process for collecting objective facts and eliminating cases with undesirable fact patterns; thus, only cases lacking bad facts—and having at least some good facts—are brought to an attorney's attention. Second, most of the administrative work is performed by the system, saving a lot of expensive lawyer time. Third, the process is structured, facilitating comparison of cases submitted to the system; this is particularly important when there are more cases than can be accepted and/or managed. That is, when only a small number of cases can be accepted due to resource constraints, it is desirable to be able to efficiently select the best of the presented cases for acceptance by weeding out cases with undesirable facts, then combining an objective evaluation of the case with a subjective evaluation to present, in priority order, the most desirable cases.

A comparison of the prior art GetAid system with the present invention is shown in Table 1.

TABLE 1

| GetAid | Present System |
|---|---|
| evaluates client | |
| financial status to | |
| determine if eligible | |
| for legal aid | |
| evaluate likelihood of | evaluate likelihood of case succeeding (liability) |
| case succeeding | evaluate size of likely damages award |
| | score case based on liability and damages |
| | produces schedule and budget |
| | produces draft pleadings |
| can only approve | can only reject cases, human assessment |
| cases | needed to approve or refer a case |
| machine learning | machine learning used to define liability and |
| used to tune weights | damages elements, and to tune weights |
| | in some embodiments, automatically incorporates |
| | new law |

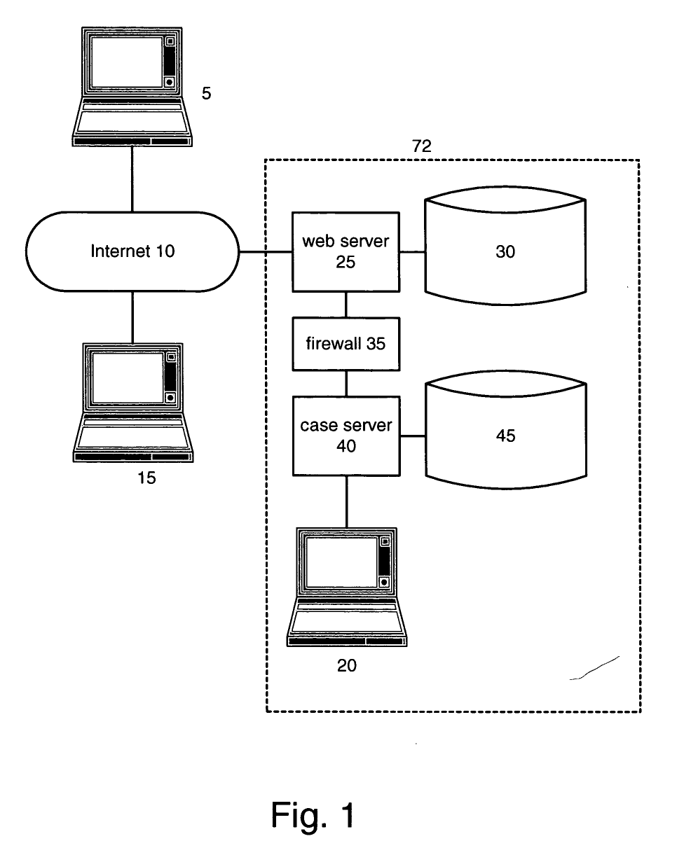

Turning to FIG. 1, an embodiment of the present system is depicted. Claimant terminal 5, referral receiving terminal 15 and case evaluation system 72 are coupled to Internet 10. The coupling may be via a wireline or wireless communication link, and may be a direct or dial-up connection. In some embodiments, the present system is operated locally within a law office or agency; if so, Internet 10 is replaced by a local network.

Case evaluation system 72 includes web server 25 coupled to Internet 10. Web server 25 functions as a communications interface. Web server 25 has storage 30 for holding the programming and graphics for interacting with a claimant. Web server 25 is also coupled to firewall 35, which in turn is coupled to case server 40. Case server 40 has storage 45 for holding (i) the data related to cases, (ii) the programming for evaluating and managing the cases, and (iii) the programming for interacting with a local case administrator and local attorneys. Firewall 35 serves to isolate case server 40 and its information from access by unauthorized parties. Administrative terminal 20 is coupled to case server 40.

Each of claimant terminal 5, referral receiving terminal 15 and administrative terminal 20 is a general purpose personal computer programmed to operate with case evaluation system 72; generally, this means the terminals execute browser software operational with hypertext transfer protocol (http) to send and receive information. In other embodiments, a protocol other than http is employed.

Each of web server 25, firewall 35 and case server 40 is at least one general-purpose computer including a processor programmed according to the present invention. If more than one general-purpose computer is provided, the computers are connected in a suitable network.

Each of storage 30 and storage 45 is at least one general-purpose data storage device, and may be magnetic, optical, magneto-optical or any other technology suitable for providing appropriate read/write access to the stored information. If a plurality of data storage devices are provided as either storage 30 or storage 45, they are networked in suitable manner.

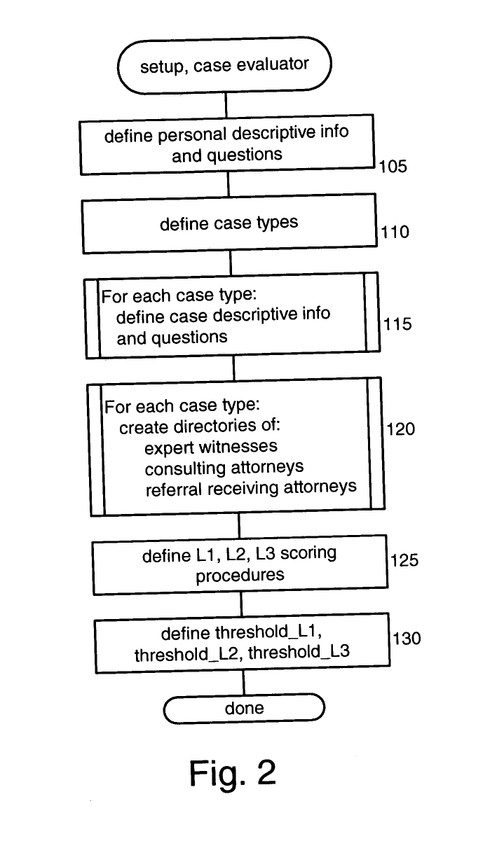

FIG. 2 depicts set-up of case evaluation system 72.

At step 105, personal descriptive information and questions are defined. For example, “claimant name” is one instance of personal descriptive information, and “What is your name” is an instance of a question for personal descriptive information. Table 2 provides representative questions for personal descriptive information. It will be appreciated that the questions are structured as a tree, wherein the branches provide more detail. For example, question (3)(g)(ii) is a third tree-level question.

TABLE 2

| | |
|---|---|
| 2. | Is Claimant a corporation or an LLC |
| 3. | If Claimant is a corporation, state the following: |

| | |
|---|---|
| a. | Date of incorporation |
| b. | State of incorporation |
| c. | State the name, address and telephone number of the person forming the corporation. |
| d. | Was the person forming the corporation an attorney? If so, please provide the name, |
| | address and telephone number of such attorney. |
| e. | Is Claimant a publicly traded company? If the answer is in the affirmative, |
| | identify the exchange and symbol. |
| f. | Identify the corporation's officers and directors. |
| g. | Is Claimant a non profit corporation or entity? If the answer is in the |
| | affirmative, state the following: |

| | |
|---|---|
| i. | Has the corporation received non profit status from the IRS? |
| ii. | What is the nature of the business for which non profit status has been |
| | granted? |
| ii. | Identify the corporation's officers and directors. |

| | |
|---|---|
| h. | If Claimant is an LLC, state the names of the majority member(s) and the minority |
| | member(s), if less than ten (10) members |
| i. | Is Claimant a general partnership? |

| | |
|---|---|
| i. | If the answer is in the affirmative, |
| | in which state have the articles of partnership been filed? |
| ii. | Identify all partners by name, address and telephone number. |
| iii. | Identify the proportion of ownership of each partner in the partnership. |

| | |
|---|---|
| j. | Is Claimant a limited partnership? |

| | |
|---|---|
| i. | If the answer is in the affirmative, in which |
| | state have the articles of partnership been filed? |
| ii. | Identify all limited partners by name, address and telephone number. |
| iii. | Identify all general partners by name, address and telephone number and indicate |
| | whether a general or limited partner. |
| iv. | Identify the proportion of ownership of each partner in the partnership. |

| | |
|---|---|
| 4. | Name of Adverse Party |
| 5. | Is the Adverse Party a corporation, LLC, partnership (general or limited) or other entity? |
| 7. | Has Claimant been a prior plaintiff or defendant in any action? If the answer is in |
| | the affirmative, state the following: |

| | |
|---|---|
| a. | Was Claimant a prior plaintiff or defendant? |
| b. | Describe the nature of the action; |
| c. | The identity of other plaintiffs and defendants; |
| d. | The title of the case; |
| e. | The location where the case was filed; |
| f. | The case number; |
| g. | Has the case been concluded, including appeals? If the answer is in the |
| | affirmative, what was the disposition? If the case is still pending, describe the status. |
| h. | In connection with such case(s), was a deposition taken of the Claimant? If the answer is in |
| | the affirmative; identify the custodian of a copy of such deposition. |

| | |
|---|---|
| 8. | Has the Adverse Party been a prior plaintiff or defendant in any action? If the answer |
| | is in the affirmative, state the following: |

| | |
|---|---|
| a. | Was the Adverse Party a prior plaintiff or defendant? |
| b. | Describe the nature of the action; |
| c. | The identity of other plaintiffs and defendants; |
| d. | The title of the case; |
| e. | The location where the case was filed; |
| f. | The case number; |
| g. | Has the case been concluded, including appeals? If the answer is in the |
| | affirmative, what was the disposition? If the case is still pending, describe the status. |
| h. | In connection with such case(s), was a deposition taken of the Adverse Party? If the answer |
| | is in the affirmative; identify the custodian of a copy of such deposition. |

| | |
|---|---|
| 9. | What is the length of time that Claimant has been in the business which is the subject |
| | of this Claim? |
| 10. | What is the length of time that the Adverse Party has been in the business which is |
| | is the subject of the Claim? |
| 11. | Does Claimant have D and O, errors and omissions or other insurance coverage that |
| | provides for indemnity in the event of suit against Claimant? If the answer |
| | is in the affirmative, state the following: |

| | |
|---|---|
| a. | The named insureds; |
| b. | The type of policy, i.e., general liability, D and O; |
| c. | The policy period; and |
| d. | The policy limits. |

| | |
|---|---|
| 12. | Does the Adverse Party have Directors and Officers, errors and omissions or other |
| | insurance coverage that provides for indemnity in the event of suit against the Adverse Party? If |
| | the answer is in the affirmative, state the following |

| | |
|---|---|
| a | The named insureds; |
| b. | The type of policy, i.e., general liability, D and O; |
| c. | The policy period, and |
| d. | The policy limits. |

| | |
|---|---|
| 13. | Have any of Claimants officers, including its President, CEO, COO, CFO, director |
| | or Chairman of the Board resigned or been terminated within the last two (2) years? If the |
| | answer is in the affirmative, state the following: |

| | |
|---|---|
| a. | The name and last known address of such offer director or Chairman; |
| b. | The basis for the termination or resignation; and |
| c. | The date of the termination or resignation; |
| d. | Has such person made a claim against Claimant for any purpose? |
| | If the answer is in the affirmative state the following: |

| | |
|---|---|
| i. | The name, last known address and last known telephone number of such person; |
| ii. | The basis for the claim; |
| iii. | The response to the claim; and |
| iv. | The status of the claim |

| | |
|---|---|
| 14. | Have any of the adverse parties officers, including its President, CEO, COO, CFO, |
| | director or Chairman of the Board, resigned or been terminated within |
| | the last two (2) years? If the answer is in the affirmative, state the following: |

| | |
|---|---|
| a. | The name and last known address of such offer director or Chairman; |
| b. | The basis for the termination or resignation; |
| c. | The date of the termination or resignation; and |
| d. | Has such person made a claim against the Adverse Party for any purpose? |
| | If the answer is in the affirmative state the following: |

| | |
|---|---|
| i. | The name, last known address and last known telephone number |
| | of such person; |
| ii. | The basis for the claim; |
| iii. | The response to the claim; and |
| iv. | The status of the claim |

| | |
|---|---|
| 15. | Has Claimant made any prior claims under any insurance policy? If the answer |
| | is in the affirmative, state the following: |

| | |
|---|---|
| a. | The nature and basis of the claim; |
| b. | The date of the claim; |
| c. | The identity of the insurance company; and |
| d. | The result of the claim. |

At step 110, case types are defined. Table 3 provides representative case types.

TABLE 3

| | |
|---|---|
| 1. | Commercial/Business/Banking |
| 2. | Insurance Claim against own insurance company |
| 3. | Breach of contract (verbal) |
| 4. | Breach of contract (written) |
| 5. | Family law, property dispute |
| 6. | Defamation, Libel or Slander |
| 7. | Real Estate |
| 8. | Negligence |

At step 115, for each case type, case descriptive information and questions are defined. Table 4 provides representative questions for case descriptive information for defamation. In one embodiment, the questions are created manually. In other embodiments, the elements are created and updated by a computer program, as described below. In this embodiment, the law is determined in advance of receiving a case. In other embodiments, the law is determined when the case is received, as described below. In yet other embodiments, the basic law is determined in advance, and details are determined when the facts of the case are received.

TABLE 4

| | |
|---|---|
| 1. | Was the information disseminated by the Adverse Party inaccurate? |

| | |
|---|---|
| a. | If yes, in what way was the information inaccurate |

| | |
|---|---|
| 2. | What are the facts that show the information was inaccurate? |
| 3. | To whom was the defamatory information disseminated? |
| 4. | When was the defamatory information disseminated? |
| 5. | What damages has Claimant sustained as a result of the |
| | defamation? |
| 6. | What is the basis for the claimed damages? |
| 7. | Has Claimant sustained a financial loss as a result of the |
| | defamation? If yes, |

| | |
|---|---|
| a. | What is the amount of financial loss? |
| b. | What is the method used to calculate financial loss? |
| c. | Is the loss continuing? |

| | |
|---|---|
| 8. | State the relationship between Claimant and Adverse Party |

At step 120, for each case type, a directory of expert witnesses is created, a directory of consulting attorneys is created, and a directory of referral receiving attorneys is created. In one embodiment, the directory is created manually. In other embodiments, the directory is created automatically, such as by extracting names of experts from reported legal decisions, or by automatically searching the Internet for parties of appropriate expertise.

At step 125, the L1, L2, L3 scoring procedures are defined. Generally, the score is computed as follows: each of the liability and damages elements is given a weighting, such as a number from 1 to 100. The claimant's information is translated to a score in a range, such as −5 to +5; no information maps to a 0. Each individual score is multiplied by the appropriate weight, and the weighted individual scores are summed to produce an overall score. In other embodiments, other scoring procedures are used.

At step 130, the scoring thresholds for L1, L2 and L3 are defined. Generally, the L1 threshold is set so as to eliminate cases with major flaws, such as insufficient time to prepare the case, an adverse party that cannot pay and so on. The L2 and L3 thresholds are set to provide a number of cases that generally corresponds with the staff available to investigate the cases. In other embodiments, the thresholds are set differently.

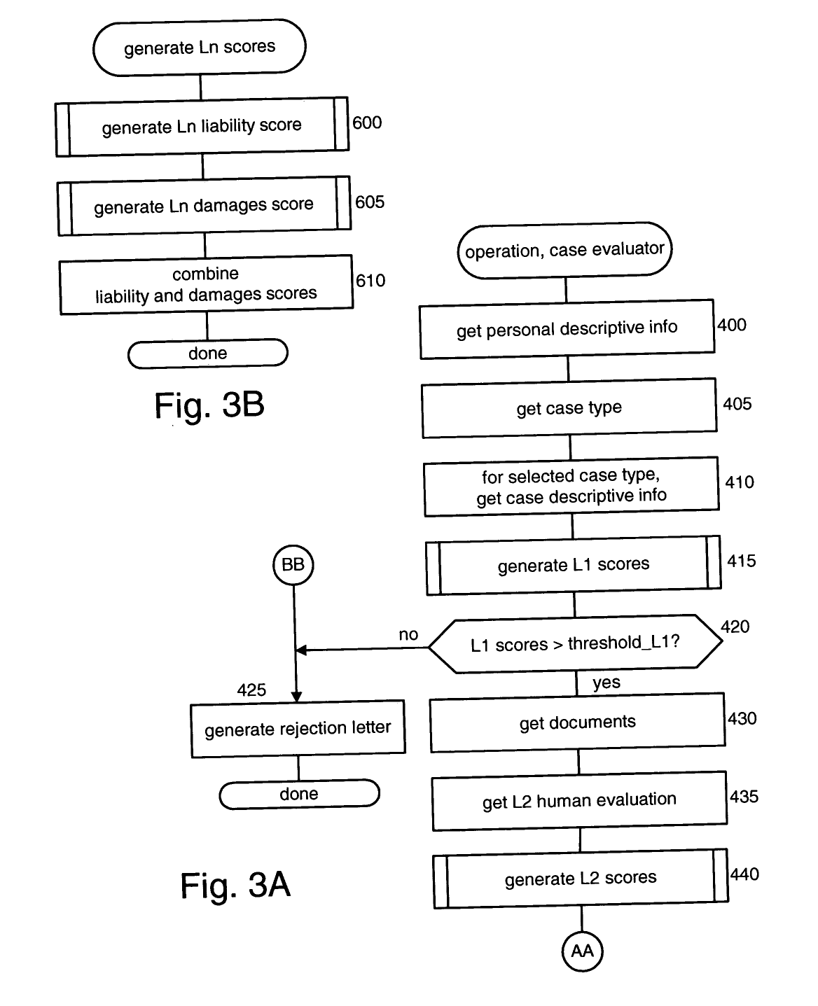

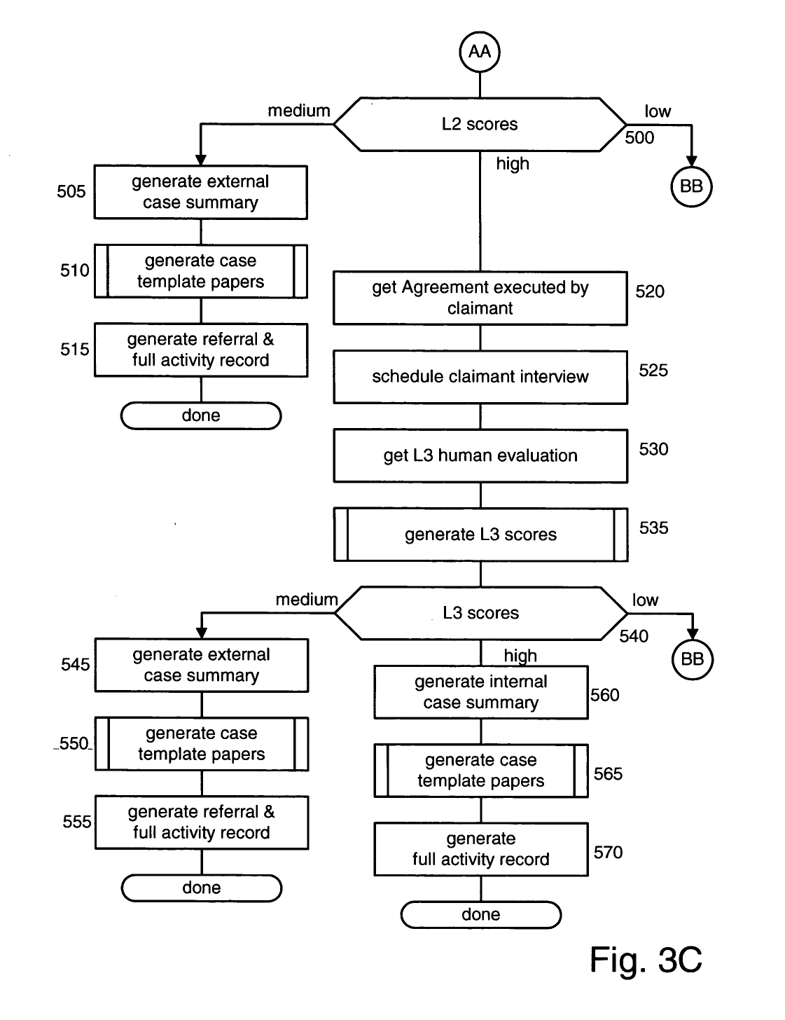

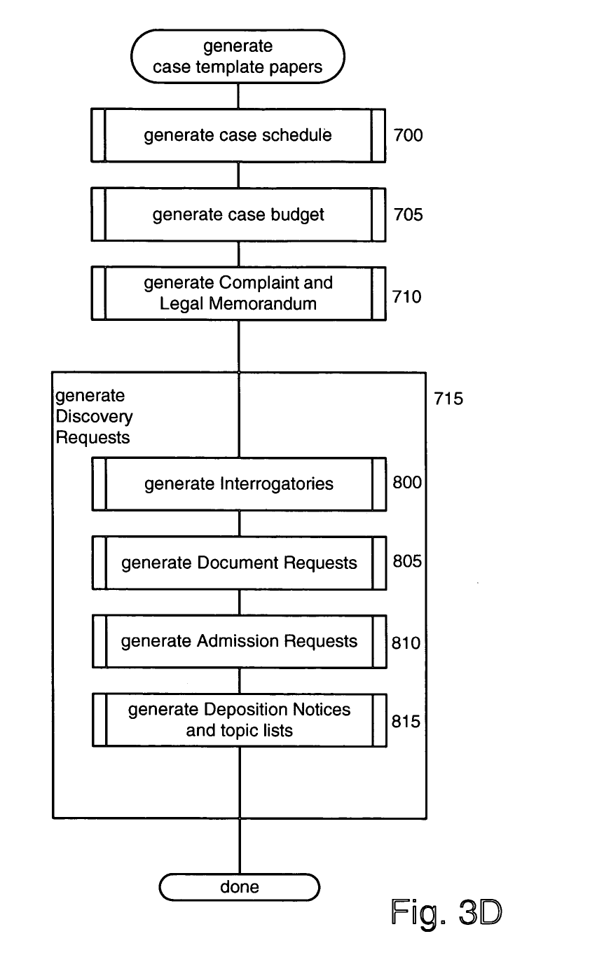

FIGS. 3A-3D are a flowchart depicting overall operation of case evaluation system 72. A first operational phase will now be described. In the first operational phase referred to as “L1”, the claimant enters liability and damages information about his or her case, and the system computes a first score. If the score is below a first threshold, the case is rejected, and a rejection letter is prepared and sent to the claimant.

Turning to FIG. 3A, at step 400, case evaluation system 72 obtains personal descriptive information. Generally, this information is obtained by web server 25 presenting questions to claimant terminal 5, and receiving responses to the questions from claimant terminal 5. It will be recalled that the personal descriptive questions were defined at step 105 of FIG. 2. The responses are passed from web server 25 via firewall 35 to case server 40 and placed in storage 45.

At step 405, system 72 obtains the case type, in similar manner as it obtained the personal descriptive information. System 72 uses the case type to select which case descriptive questions to present to the claimant.

At step 410, system 72 obtains case descriptive information. Generally, this information is obtained by web server 25 presenting questions to claimant terminal 5, and receiving responses to the questions from claimant terminal 5. It will be recalled that the case descriptive questions were defined at step 115 of FIG. 2. The responses are passed from web server 25 via firewall 35 to case server 40 and placed in storage 45.

At step 415, system 72 generates an L1 score, as shown in FIG. 3B.

Generally, the score for a level Ln, n=1,2 or 3, is given as the sum of the liability score and the damages score for the level. Each of the liability and damages scores is determined by assigning a score to the elements and multiplying the score by a weight for that element. In some embodiments, the liability and damages scores are combined in a different manner to give an overall score.

In FIG. 3B, at step 600, the liability score for level Ln is generated, n=1, 2 or 3:
Ln liability=Σᵢ(weight for liability element i)*(score for liability element i)
At step 605, the damages score for level Ln is generated, n=1, 2 or 3:
Ln damages=Σⱼ(weight for damages element j)*(score for damages element j)
At step 610, the liability and damages scores for this level are combined to give the overall score for this level:
Ln=Ln liability+Ln damages

Table 5 provides an example of a predefined scoring structure having a single liability element, deadline, and a single damage element, financial damages, to be combined.

TABLE 5

| weight | factor | element score | element value |
|---|---|---|---|
| 50 | liability element: | −5 | <3 month |
| | deadline for filing | −2 | 3-6 months |
| | complaint | 1 | 6-12 months |
| | | 3 | >12 months |
| 100 | damages element: | −5 | <$20k |
| | financial damages | −1 | $20k-100k |
| | | 2 | $100k-1m |
| | | 3 | $1m-10m |
| | | 5 | >$10m |

As an illustration, let it be assumed that a particular case has a deadline for filing the complaint in 7 months, corresponding to an element score of −2, and has financial damages of $200,000, corresponding to an element score of 2. The overall score for this level is
example level score=50*(−2)+100(2)=100

Returning to FIG. 3A, at step 420, system 72 compares the L1 score to the L1 threshold. It will be recalled that the L1 threshold was defined at step 130 of FIG. 2.

If the case score is below the L1 threshold, processing proceeds to step 425, where system 72 generates a rejection letter and presents the rejection letter to the claimant. Generally, this occurs by presenting the letter via claimant terminal 5; in some embodiments, a paper letter or an e-mail letter is sent to the claimant. If the case score is above the L1 threshold, processing proceeds to the second phase.

A second operational phase will now be described.

In the second operational phase, referred to as “L2”, key documents are collected and administratively verified. In some cases, a junior attorney provides a basic evaluation. The system then computes a second score. If the score is below a second threshold, the case is referred to a third party attorney.

At step 430, case evaluation system 72 gets key documents for the case.

In a manual embodiment, a human reviews the information submitted at L1, decides which documents should be reviewed, and requests the documents from the claimant such as by entering a document request via administrative terminal 0, which converts the document request to an e-mail message, and sends the e-mail message to claimant terminal 5 via case server 40, firewall 35 and web server 25.

In an automated embodiment, system 72 has a list of which documents should be provided for each case type, and presents this list to claimant terminal 5.

The claimant can submit the documents in one or more ways, such as by mailing the documents to system 72 for scanning by an administrator, scanning the documents and attaching a file of the scanned documents to an e-mail to system 72, uploading a file of the scanned documents to system 72 and so on. System 72 places an electronic file corresponding to the received documents in storage 45, associated with the claimant's case.

A human administrator or junior attorney next reviews the documents. The human checks that the document contents match the information that the claimant has provided. The human may optionally generate more questions for the claimant and send these questions to the claimant, typically via an email or by a web-interface that requires the claimant to enter the information using an http protocol or the like, or via paper mail; if so, the human manually scores the responses and enters the scores for these elements to system 72 as either adjustments to existing element scores or as new element scores. The human provides subjective scores relating to the strength of the claimant's liability and damages issues.

At step 435, system 72 receives the human's L2 evaluation, comprising objective and possibly subjective liability and damages scores, and optionally new scores for information responsive to additional questions presented to the claimant.

At step 440, system 72 generates an L2 score in similar manner as used to generate an L1 score.

Turning to FIG. 3C, at step 500, case evaluation system 72 compares the L2 score to the L1 and L2 thresholds.

If the case score is below the L1 threshold, processing proceeds to step 425, where system 72 generates a rejection letter and presents the rejection letter to the claimant.

If the case score is above the L1 threshold and below the L2 threshold, processing proceeds to step 505.

If the case score is above the L2 threshold, processing proceeds to the third phase.

At step 505, system 72 generates an external case summary, which is basically a narrative description of what has occurred so far.

At step 510, system 72 generates case template papers, as shown in detail in FIG. 3D. The case template papers are intended as “starter” documents for the attorney handling the case, enabling the attorney to spend her time adapting the documents to the particular case. The method conventionally used to create case documents is cutting and pasting from other cases and formbooks of paragraphs for various case types, and then adapting to the instant case.

Turning to FIG. 3D, at step 700, the case schedule is generated by system 72. In one embodiment, the schedule is generated by simple table look-up. Specifically, system 72 decides whether a case is “simple”, “average” or “complex” based upon various factors. In one embodiment, the factors are simply the size of the estimated damages, with, for example, “simple” being under $100,000; “average” being between $100,000 and $1 million, and “complex” being over $1 million. In other embodiments, other factors are used such as whether the parties reside in different states and so on. Table 6 shows an example of the look-up table of case schedules.

TABLE 6

| schedule element | simple case | | average case | | complex case | |
|---|---|---|---|---|---|---|
| Research | 10 | days | 20 | days | 40 | days |
| Prepare and File | 3 | days | 5 | days | 15 | days |
| Complaint | | | | | | |
| Review Response | 60 | days | 60 | days | 60 | days |
| Status Conference | 1 | day | 1 | day | 1 | day |
| Discovery | 120 | days | 240 | days | 480 | days |
| Mediation | 60 | days | 60 | days | 60 | days |
| Motions | 60 | days | 80 | days | 100 | days |
| Final Status | 1 | day | 1 | day | 1 | day |
| Conference | | | | | | |
| Trial preparation | 60 | days | 60 | days | 60 | days |
| Trial | 3 | days | 7 | days | 21 | days |
| Post-trial Motions | 60 | days | 60 | days | 60 | days |

In some embodiments, the schedule times are determined by computation, rather than table look-up. For example, the discovery time can be a function of the estimated number of documents and estimated number of parties and witnesses to be deposed.

At step 705, the case budget is generated. In one embodiment, the budget is obtained by simple table look-up. Specifically, system 72 decides whether a case is “simple”, “average” or “complex” based upon various factors as discussed above. Table 7 shows an example of the look-up table of case budgets.

TABLE 7

| budget element | simple case | | average case | | complex case | |
|---|---|---|---|---|---|---|
| Research | 10 | hours | 30 | hours | 120 | hours |
| Prepare Complaint | 7 | hours | 20 | hours | 50 | hours |
| Review Response | 8 | hours | 30 | hours | 100 | hours |
| (Answer/Demurrer) | | | | | | |
| Status Conference | 5 | hours | 10 | hours | 20 | hours |
| Discovery, document | 5 | hours | 30 | hours | 100 | hours |
| review | | | | | | |
| Discovery, | 60 | hours | 200 | hours | 1000 | hours |
| depositions | | | | | | |
| Discovery, prepare | 10 | hours | 20 | hours | 40 | hours |
| requests | | | | | | |
| Discovery, respond to | 10 | hours | 50 | hours | 200 | hours |
| requests | | | | | | |
| Expert Discovery | 20 | hours | 50 | hours | 200 | hours |
| Motions | 100 | hours | 500 | hours | 1000 | hours |
| Mediation | 20 | hours | 50 | hours | 200 | hours |
| Final Status | 5 | hours | 10 | hours | 20 | hours |
| Conference | | | | | | |
| Trial preparation | 200 | hours | 1000 | hours | 5000 | hours |
| Trial | 30 | hours | 100 | hours | 2500 | hours |
| Post-trial Motions | 20 | hours | 100 | hours | 500 | hours |

At step 710, a draft Complaint and Legal Memorandum are generated for the case.

The Complaint is a formal document having parts as shown in Table 8. System 72 obtains the information for the Complaint parts as generally indicated in Table 8.

TABLE 8

| name of part | example | where information obtained |
|---|---|---|
| Filing Attorney | Jane Wu, Esq. | stored contact information for |
| Contact | Wu Law Firm | outside attorney to whom case is |
| Information | 100 Main Street | being referred |
| | Encino, CA 90231 | |
| Case Caption | ABC CORPORATION, a California | information entered by claimant |
| | Corporation, and A, an individual, v. X | and L2 and L3 attorneys |
| | CORPORATION | |
| COMPLAINT | COMPLAINT FOR DEFAMATION | predefined based on case type |
| title | | entered by claimant |
| Jurisdiction | See Table 20, paragraphs 1-3 | predefined statement based on |
| | | type of case indicated by |
| | | claimant and location |
| Venue | See Table 20, paragraphs 1-3 | predefined statement based on |
| | | location of claimant and |
| | | defendant |
| Identity of | See Table 20, paragraphs 1-4 | predefined “Does” paragraph |
| parties | | |
| Case Facts | See Table 20, paragraphs 5-9, also facts | information supplied by claimant |
| | included in Causes of Action | and L2 and L3 attorneys |
| Causes of Action | See Table 20, paragraphs 11-18 | predefined statements for the |
| | | type of case, information |
| | | supplied by claimant and L2 and |
| | | L3 attorneys |
| Prayer for Relief | See Table 20, the paragraph beginning | predefined statements for the |
| | with WHEREFORE | type of case |
| Signature Block | Jane Wu, Esq. | stored contact information for |
| | Wu Law Firm | outside attorney to whom case is |
| | 100 Main Street | being referred, and information |
| | Encino, CA 90231 | entered by claimant and L2 and |
| | Attorneys for Plaintiffs, ABC | L3 attorneys |
| | CORPORATION and A, an individual | |
| Proof of Service | See Table 20, paragraphs including and | predefined paragraphs |
| | following PROOF OF SERVICE | |

The Legal Memorandum is a formal document that repeats the case facts, then presents the law relating to the case facts, and explains why the facts fit into the law leading to a desired result, and distinguishes the facts from law leading to an undesired result. Generally, the Legal Memorandum must be prepared by an attorney. However, system 72 provides a template including predefined paragraphs of the law based on the type of case selected and the location where the subject of the Complaint occurred.

At step 715, draft discovery requests are generated. As specified in federal and state Rules of Civil Procedure, discovery requests include Interrogatories, Document Requests and Admission Requests. For system 72, discovery requests generally also include Deposition Notices and topics are generated for the various parties and witnesses. See steps 800-815. Discovery requests are formal documents having parts as shown in Table 9. System 72 obtains the information for the discovery request parts as generally indicated in Table 9. Table 9's “example” column refers only to interrogatories, but comparable types of information are in the document requests and admissions requests.

TABLE 9

| name of part | Example | where information obtained |
|---|---|---|
| Filing Attorney | Jane Wu, Esq. | stored contact information |
| Contact | Wu Law Firm | for attorney to whom case |
| Information | 100 Main Street | is being referred |
| | Encino, CA 90231 | |
| Case Caption | ABC CORPORATION, a California | information entered by |
| | Corporation, and A, an individual, v. X | claimant and L2 and L3 |
| | CORPORATION | attorneys |
| Title of | PLAINTIFFS' INTERROGATORIES, SET | predefined |
| Discovery | ONE | |
| Request | | |
| Form paragraphs | Propounding Party: PLAINTIFF | predefined information and |
| | Responding Party: DEFENDANT | names in case caption |
| | Set No.: ONE | |
| | Plaintiff NAME hereby requests that | |
| | Defendant NAME answer under oath, | |
| | pursuant to Cal. Code of Civil Procedure | |
| | §2030, the following Interrogatories. | |
| General | See Table 23, Interrogatory No. 0 | predefined information for |
| discovery request | | all interrogatories |
| Specific | See Table 23, Interrogatories No. 1-10 | predefined information for |
| discovery | | this type of case, and |
| requests for this | | information supplied by |
| case | | claimant and L2 and L3 |
| | | attorneys |
| Signature Block | Jane Wu, Esq. | stored contact information |
| | Wu Law Firm | for outside attorney to |
| | 100 Main Street | whom case is being |
| | Encino, CA 90231 | referred, and information |
| | Attorneys for Plaintiffs, ABC | entered by claimant and L2 |
| | CORPORATION and A, an individual | and L3 attorneys |
| Proof of Service | See Table 20, paragraphs including and | predefined paragraphs |
| | following PROOF OF SERVICE | |

A deposition notice is a formal paper that officially puts the other side of the litigation on notice that a deposition will be taken of a person. The parties to the case are always noticed for deposition. Anyone having material information about the case should be noticed for deposition. Of course, just because system 72 generates a deposition notice does not require the attorney handling the case to actually serve the deposition notice.

System 72 may generate a list of deposition topics for each deponent. The deposition topics for a deponent are generally (i) the facts that the deponent has personal knowledge of, (ii) case descriptive elements that are unknown by the claimant, and (iii) topics identified by the L2 or L3 attorney as associated with the deponent.

System 72 may generate draft jury instructions for the case. There are formbooks of jury instructions for various types of cases; system 72 selects pertinent paragraphs and provides them as draft jury instructions.

Returning to FIG. 3C, at step 515, system 72 generates a case referral to one of the referral receiving attorneys in the directory established at step 120 of FIG. 2. The referral receiving attorney is selected via any suitable method, such as round-robin, expressed preference for cases with certain characteristics and so on. The case referral comprises the external case summary and the case template papers. Optionally, a written evaluation from the human who performed the L2 evaluation may be included. The case referral is sent to the referral receiving attorney either via an attachment to an email or by an email notifying the referral receiving attorney that the referral is ready for downloading from system 72 to referral receiving terminal 15. In some cases, the case referral is copied to a portable storage medium, such as a compact disc (CD) and physically mailed to the referral receiving attorney.

Also at step 515, system 72 generates a full activity record, including the referral, when it was delivered and so on, and places the full activity record in storage 45. The full activity record serves as an audit trail for the case.

A third operational phase will now be described.

In the third operational phase, referred to as “L3”, the claimant is interviewed by a human, preferably a senior attorney. Information gaps are filled or noted. A subject matter expert and/or a consulting attorney may assist in evaluating the case. The senior attorney provides an evaluation of the claimant and the gathered facts. The system then computes a third score. If the score is below a third threshold, the case is referred to an outside attorney. If the score is above the third threshold, the case is accepted for further consideration.

At the start of the third operational phase, the claimant is required to sign an Agreement relating to processing of the case. In the L3 phase, it is often necessary to hire a subject matter expert and/or a consulting attorney to properly evaluate the case, and the claimant must agree to either pay for such evaluations, or agree to be compensate the operator of system 72 so that the evaluation fees can be recovered from the damages award or settlement of the case, if any.

At step 520 of FIG. 3C, case evaluation system 72 receives the Agreement executed by the claimant. The Agreement is transmitted by any suitable means, such as uploading to the web site provided by system 72, attaching to an email sent to system 72, or a paper document sent to system 72 and scanned by an administrator. A file representing the received Agreement is placed in storage 45 in association with the claimant's case.

At step 525, system 72 schedules an interview between the claimant and a human representing the operator of system 72, preferably a senior attorney.

The L3 human administrator or senior attorney, and the claimant, participate in the interview, which is preferably an in-person interview. The human records and scores his/her perceptions of the claimant with regard to considerations such as being an easy-to-work with client, being a credible witness, being a sympathetic witness and so on.

The L3 human verifies the accuracy of the information submitted by the claimant, such as by confirming incorporation status of a company via third party databases.

The L3 human optionally does additional legal research for the case.

The L3 human hires experts as appropriate to give opinions on the case. For example, a subject matter expert such as an engineer is hired if complicated technology is involved. If an unusual area of law is implicated, such as admiralty, a consulting attorney is employed. In some cases, an investigator is employed to verify facts and/or obtain additional information.

At step 530, system 72 receives the human's L3 evaluation, comprising objective and subjective liability and damages scores, and a written report based on all the fact finding and legal research performed during the L3 information gathering.

At step 535, system 72 generates an L3 score, in the same manner as described above for the L2 and L1 scores.

At step 540, case evaluation system 72 compares the L3 scores to the L1 and L3 threshold.

If the case score is below the L1 threshold, processing proceeds to step 425, where system 72 generates a rejection letter and presents the rejection letter to the claimant.

If the case score is above the L1 threshold and below the L3 threshold, processing proceeds to step 545.

If the case score is equal to or above the L3 threshold, processing proceeds to step 560.

At step 545, system 72 generates an external case summary, which is basically a narrative description of what has occurred so far. At step 550, system 72 generates case template papers as described above. At step 555, system 72 generates a referral to one of the referral receiving attorneys in the directory established at step 120 of FIG. 2, using a similar procedure as described above with regard to step 515. Also at step 555, system 72 generates a full activity record, including the referral, when it was delivered and so on, and places the full activity record in storage 45.

At step 560, system 72 generates an internal case summary. An internal case summary is similar to an external case summary, but differs in that it includes working notes of the L2 and L3 attorneys participating in the evaluation.

At step 565, system 72 generates case template papers as generally discussed above.

At step 570, system 72 generates a full activity record, including the referral, when it was delivered and so on, and places the full activity record in storage 45.

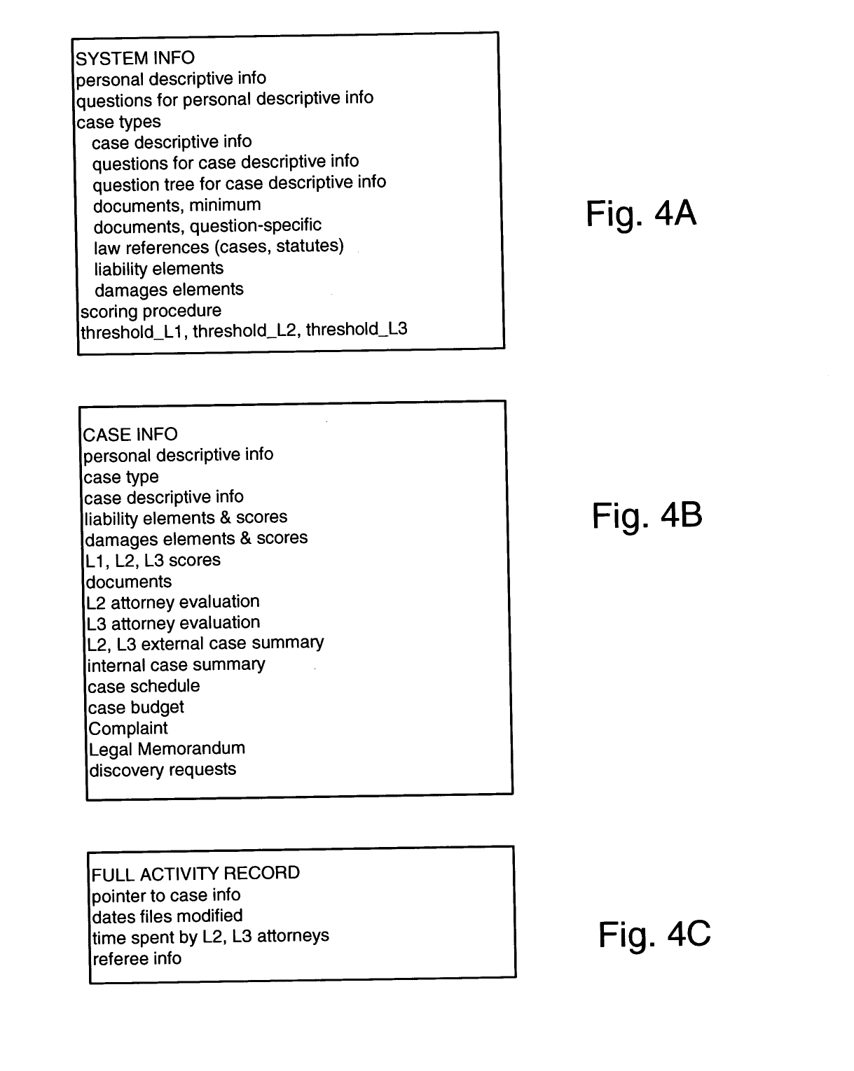

FIGS. 4A-4C are block diagrams illustrating data structures used by case evaluation system 72.

FIG. 4A shows system information representing data and programming code used by system 72, that is pre-defined lists of information and associated questions intended to elicit the pre-defined information from a claimant. System information also includes predefined procedures, such as the scoring procedure.

FIG. 4B shows case-specific information, that is, all of the substantive information associated with a case: information submitted by a claimant, evaluations made by attorneys, and case-specific information generated by system 72 for this case including scores and documents.

FIG. 4C shows the full activity record for a case, that is, the substantive information indicated by reference to the case-specific information, as well as the procedural information including dates and times that the case-specific information was modified and by whom, typically used for an audit trail, and the amount of time spent by evaluating attorneys, which is useful if the attorney to whom a case is referred is responsible for paying for the time spent by evaluating attorneys.

An exemplary use case illustrating operation of case evaluation system 72 in the area of defamation will now be discussed.

Assume that selected liability elements are as shown in Table 10.

TABLE 10

| weight | factor | score | element |
|---|---|---|---|
| 100 | information | 3 | yes, written |
| | disseminated | 2 | yes, oral |
| | | 4 | yes, both |
| | | −4 | no |
| 75 | inaccurate | 4 | yes |
| | information | 2 | no but private |
| | | −2 | no and not private |
| 75 | to whom information | 4 | credit bureau |
| | disseminated | 3 | existing customers |
| | | 2 | marketplace |
| | | 0 | uninterested party |
| | | 2 | government agency |
| 50 | contract facts | 4 | written contract and |
| | | | undisputed |
| | | −2 | written contract in |
| | | | dispute |
| | | 3 | existing customer, |
| | | | oral agreement |
| | | −1 | industry association |
| | | 3 | competitor |

Assume that selected damages elements are as shown in Table 11.

TABLE 11

| weight | factor | score | element |
|---|---|---|---|
| 100 | economic, present | −4 | under $10,000 |
| | | −3 | $10,000-100,0000 |
| | | 2 | $100,000-$1 million |
| | | 4 | over $1 million |
| 75 | economic, future | −4 | under $10,000 |
| | | −3 | $10,000-100,0000 |
| | | 1 | $100,000-$1 million |
| | | 2 | over $1 million |
| 25 | non-economic | −4 | under $10,000 |
| | damages, present | −3 | $10,000-100,0000 |
| | | −1 | $100,000-$1 million |
| | | 1 | over $1 million |
| 100 | defendant's financial | 0 | unknown |
| | condition | −2 | under $10m revenue |
| | | 3 | $10m-$1billion rev |
| | | 4 | over $1billion revenue |

Assume the following facts. Company ABC, the claimant, has a contract with Company X, the defendant, to lease equipment. Company X has $50 million in annual revenues. At the end of the contract, Company X claimed more money was due. Company ABC denied this. Company X reported Company ABC to a credit reporting agency as being a collection account for the amount claimed by Company X. As a consequence, Company ABC was unable to purchase or lease equipment on credit, and thus could not manufacture product for its existing customers causing a loss of $250,000 of business, or develop new business causing an estimated loss of $1.5 million. There are no non-economic damages.

The L1 liability and damages calculations are shown in Tables 12 and 13.

TABLE 12

| weight | factor | Score | element | weighted score |
|---|---|---|---|---|
| 100 | information | 3 | yes, written | 300 |
| | disseminated | | statement to credit | |
| | | | agency | |
| 75 | inaccurate | 4 | yes, no debt | 300 |
| | information | | existed | |
| 75 | to whom | 4 | credit bureau | 300 |
| | information | | | |
| | disseminated | | | |
| 50 | contract facts | −2 | written contract in | −100 |
| | | | dispute as to | |
| | | | whether more | |
| | | | money due | |

| | |
|---|---|
| Liability Score, L1 | 800 |

TABLE 13

| weight | factor | Score | element | weighted score |
|---|---|---|---|---|
| 100 | economic, present | 2 | $100,000-$1 | 200 |
| | | | million | |
| 75 | economic, future | 2 | over $1 million | 150 |
| 25 | non-economic | −4 | under $10,000 | −100 |
| | damages, present | | | |
| 100 | defendant's | 3 | $10m-$1billion | 300 |
| | financial condition | | rev | |

| | |
|---|---|
| Damages Score, L1 | 550 |

The L1 Score=L1 Liability Score+L1 Damages Score=800+550=1350. Assume that the L1 Score Reject Threshold=500. Here, the score is sufficiently high to move to L2.

At L2, the following documents are provided: 1. the underlying contract; 2. correspondence between the parties showing a dispute about the amount due; 3. the information disseminated, namely, a negative report about Company ABC from the credit agency; 4. letters from lenders refusing credit to Company ABC, stating that the poor credit report is why credit was denied; 5. a worksheet showing how present and future economic damages were computed; and 6. a financial statement for Company X showing its annual revenues.

The L2 attorney evaluates the documents, noticing that the contract requires an extra payment if Company ABC is late in returning the leased equipment to Company X, but Company ABC has proof that it timely delivered the leased equipment to Company X. The L2 attorney also notices that Company ABC had a prior poor credit history. Finally, the L2 attorney asks the claimant how much business it did with each of its customers, and the L2 attorney decides that the actual amount of lost business is $1.1 million. Accordingly, the L2 attorney adjusts the scoring as shown in Tables 14 and 15.

TABLE 14

| | | | | weighted |
|---|---|---|---|---|
| weight | factor | Score | element | score |
| 100 | information | 3 | yes, written | 300 |
| | disseminated | | statement to | |
| | | | credit agency | |
| 10 | inaccurate | 4 | yes, no debt | 40 |
| (was 75) due | information | | existed | |
| to prior poor | | | | |
| credit rating | | | | |
| 75 | to whom | 4 | credit bureau | 300 |
| | information | | | |
| | disseminated | | | |
| 50 | contract facts | 1 | written contract | 50 |
| | | (was −2) since | in dispute as | |
| | | claimant is | to whether | |
| | | right | more money | |
| | | | due | |

| | |
|---|---|
| Liability Score, L2 | 690 |

TABLE 15

| | | | | weighted |
|---|---|---|---|---|
| weight | factor | Score | element | score |
| 100 | economic, present | 4 (was 2) since | $100,000-$1 | 400 |
| | | L2 attorney | million | |
| | | believes | | |
| | | damages are | | |
| | | $1.1 million | | |
| 75 | economic, future | 2 | over $1 million | 150 |
| 25 | non-economic | −4 | under $10,000 | −100 |
| | damages, present | | | |
| 100 | defendant's | 3 | $10m-$1billion | 300 |
| | financial | | rev | |
| | condition | | | |

| | |
|---|---|
| Damages Score, L2 | 750 |

The L2 Score=2*L2 Liability Score+L2 Damages Score=2*690+750=2130. The L2 Score Threshold=1500 and L2 Score Reject Threshold=500. Here, the score is sufficiently high to move to L3.

At L3, the L3 attorney interviews the claimant, and hires a credit expert. The credit expert advises that it will be very difficult to prove damages. The L3 attorney leaves the liability score unchanged, and changes the damages score as shown in Table 16.

TABLE 16

| | | | | weighted |
|---|---|---|---|---|
| weight | factor | Score | element | score |
| 100 | economic, | −4 (was 2 then | $100,000-$1 | −400 |
| | present | changed to 4) | million | |
| | | since L3 | | |
| | | attorney believes | | |
| | | damages are | | |
| | | hard to prove | | |
| 75 | economic, | −4 (was 2) since | over $1 million | −300 |
| | future | L3 attorney | | |
| | | believes | | |
| | | damages are | | |
| | | hard to prove | | |
| 25 | non-economic | −4 | under $10,000 | −100 |
| | damages, | | | |
| | present | | | |
| 100 | defendant's | 3 | $10m-$1billion | 300 |
| | financial | | rev | |
| | condition | | | |

| | |
|---|---|
| Damages Score, L3 | −500 |

The L3 Score=2*L3 Liability Score+L3 Damages Score=2*690−500=880. The L3 Score Threshold=2500, and L3 Score Reject Threshold=500. Here, the score is insufficiently high to move to continue, but higher than the reject threshold, so this case will be referred to another attorney. In this example, the case is referred to Jane Wu of the Wu Law Firm.

Table 17 shows the external case summary generated by system 72. Table 18 shows the schedule generated for this case. Table 19 shows the budget generated for this case; in this example, all hours are billed at the same rate. In other embodiments, a variety of billing rates can be accommodated, corresponding to partners, associates, paralegals and so on. In this example, the expert witness's billing rate is different than the attorney's billing rate. In some embodiments, a graphic is provided showing how much money is expended as time passes; this is useful for settlement decisions. Table 20 shows the complaint generated for this case. Table 21 shows the legal memorandum generated for this case. Table 22 shows the document requests generated for this case. Table 23 shows the interrogatories generated for this case. Table 24 shows the requests for admissions generated for this case. Table 25 shows a deposition notice generated for this case. Table 26 shows a list of deposition topics generated for this case. For brevity, the Proof of Service is shown only with the Complaint; in actual practice, a similar proof of service is appended to each of the legal memorandum, document requests, interrogatories, requests for admissions and deposition notices.

TABLE 17
ABC CORPORATION and A v. X CORPORATION and Does 1-10
CASE SUMMARY

| Date submitted | Apr. 11, 2005 |
|---|---|
| Claimant contact | Joe Jones, VP Purchasing, ABC Corporation, |
| information | 5000 ABC Parkland, Santa Monica, CA 90020 |
| Defendant contact | Uhrah Theef, CEO, X Corporation, 123 Elm |
| information | Street, Reseda, CA 90614 |
| Facts of Dispute | Claimant claims that Defendant willfully reported |
| | inaccurate information to the credit reporting |
| | agencies, pertaining to a contract, which has |
| | adversely affected the business. |
| Estimated Damages | $250,000 loss of business |
| | $1.5 million loss of new business |
| Element scores that are | None |
| >3 or <−3 | |
| Liability Score | 690 |
| Damages Score | −500 |
| Overall Score Formula | 2 * liability + damages |
| Overall Score | 880 |

TABLE 18
ABC CORPORATION and A v. X CORPORATION and Does 1-10
SUPERIOR COURT OF THE STATE OF CALIFORNIA, COUNTY
OF LOS ANGELES
ESTIMATE OF SCHEDULE

| | |
|---|---|
| Research, 10 days | 10 days elapsed |
| Prepare and file Complaint, 3 days | 13 days elapsed |
| Review Response to Complaint, 60 days | 73 days elapsed |
| Status Conference, 1 day | 74 days elapsed |
| Discovery, 120 days | 194 days elapsed |
| Mediation, 60 days | 254 days elapsed |
| Motions, 60 days | 314 days elapsed |
| Final Status Conference, 1 day | 315 days elapsed |
| Trial Preparation, 60 days | 375 days elapsed |
| Trial, 3 days | 378 days elapsed |
| Post-trial Motions, 60 days | 433 days elapsed |

TABLE 19
ABC CORPORATION and A v. X CORPORATION and Does 1-10
SUPERIOR COURT OF THE STATE OF CALIFORNIA, COUNTY
OF LOS ANGELES
ESTIMATE OF BUDGET

| | |
|---|---|
| Research, 10 hours @ $300/hour | $3,000 |
| Prepare Complaint, 7 hours @ $300/hour | $2,100 |
| Review Response to Complaint, 8 hours @ $300/hour | $2,400 |
| Status Conference, 5 hours @ $300/hour | $1,500 |
| Discovery, document review, 5 hours @ $300/hour | $1,500 |
| Discovery, depositions, 60 hours @ $300/hour | $18,000 |
| Discovery, prepare discovery requests, 10 hours @ $300/hour | $3,000 |
| Discovery, respond to discovery requests, 10 hours @ | $3,000 |
| $300/hour | |
| Expert Discovery, 20 hours @ $300/hour | $6,000 |
| Expert Witness fee, 10 hours @ $400/hour | $4,000 |
| Motions, 100 hours @ $300/hour | $30,000 |
| Mediation, 20 hours @ $300/hour | $6,000 |
| Final Status Conference, 5 hours @ $300/hour | $1,500 |
| Trial Preparation, 200 hours @ $300/hour | $60,000 |
| Trial, 30 hours @ $300/hour | $9,000 |
| Post-trial Motions, 20 hours @ $300/hour | $6,000 |
| TOTAL | $157,000 |
| Attorney time, 510 hours | |
| Expert Witness time, 10 hours | |

TABLE 20
Jane Wu, Esq.
Wu Law Firm
100 Main Street
Encino, CA 90231

SUPERIOR COURT OF THE STATE OF CALIFORNIA, COUNTY OF LOS ANGELES

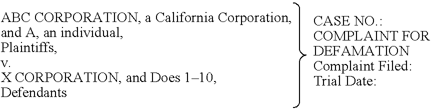

Plaintiffs ABC CORPORATION and A, an individual, allege:

GENERAL ALLEGATIONS

1. At all times herein relevant, Plaintiff ABC CORPORATION (“ABC CORPORATION”),
was and is a California corporation doing business in the County of Los Angeles, State of
California.
2. At all times herein relevant, Plaintiff A, an individual, was and is a resident of the County
of Los Angeles, State of California.
3. At all times herein relevant, Defendant X CORPORATION, was a corporation of
unknown origin doing business in the County of Los Angeles, State of California.
4. Plaintiffs are ignorant of the true names and capacities of Defendants sued herein as Does
1 through 10, inclusive, and therefore sue these Defendants by such fictitious names. Plaintiffs
will seek leave of this Court to amend their complaint to allege the true names and capacities of
these Defendants when same has been ascertained. Plaintiffs are informed and believe, and
thereon allege, that each of the fictitiously named Defendants is negligently, intentionally or
otherwise legally responsible in some manner for the occurrences as set forth herein and
Plaintiffs' injuries and damages.
5. On or about, DATE 1999, Plaintiffs entered into a commercial lease rental agreement,
No. 5322DG0396-1 (the “FIRST WIDGET AGREEMENT”), with X CORPORATION. The
FIRST WIDGET AGREEMENT provided for a $1 purchase option at the end of the term. A
true and correct copy of the FIRST WIDGET AGREEMENT, is attached hereto as Exhibit A
and incorporated herein by reference.
6. Plaintiffs made payments to X CORPORATION in the amount of $7897.00, as required
by the FIRST WIDGET AGREEMENT.
7. After the widgets did not meet Plaintiffs requirements, the Plaintiff and Defendant
agreed to cancel the FIRST WIDGET AGREEMENT.
8. Plaintiff and Defendant then agreed to a new agreement, “THE WIDGET
AGREEMENT, stating the previously paid amounts were to be applied against future lease
obligations. Defendant did not provide a copy to Plaintiff.
9. On or about DATE, 2004, Plaintiffs received a letter stating that Plaintiffs owed X
CORPORATION $8,963.07 and demanded payment.
10. When Plaintiffs refused to pay the amount demanded by X CORPORATION, it falsely
reported to credit reporting agencies that Plaintiffs owed a debt of $36,672.75. Defendant
refused to accept the $1 purchase option.

FIRST CAUSE OF ACTION
(For Libel, Against All Defendants)

11. Plaintiffs incorporate by reference each and every allegation as though fully set forth at
this point.
12. On or about 2004, X CORPORATION wrote a letter to various credit reporting
agencies that contained the following statement: “ABC CORPORATION and A owed and failed
to pay X CORPORATION a debt in the sum of $36,672.75.” A true and correct copy of said
letter is attached hereto as Exhibit B.
13. The above-described publication is false as it pertains to Plaintiffs.
14. The above described publication is libelous on its face. It clearly exposes Plaintiffs to
hatred, contempt, ridicule, and/or obloquy because it portrays Plaintiffs as dishonest and
untrustworthy, and has in fact adversely affected Plaintiffs' credit in the business community.
15. The above described publication was published in the Plaintiffs' credit report and was
seen and read by persons who reside and/or conduct business in and around Los Angeles County
and environs.
16. As a proximate result of the above-described publication, Plaintiff A has suffered loss of
his reputation, shame, mortification, and hurt feelings all to his general damage.
17. As a further proximate result of the above-describe publication, Plaintiffs
have suffered $1,750,000 in business economic loss due to the denial of credit.
18. The above-described acts of X CORPORATION were wanton, willful and malicious, in
that X CORPORATION knew said publication to be false as to Plaintiffs, and it made said
publication for the purpose of harassing and annoying Plaintiffs into relinquishing their claim to
the $7,897 in payment it had made pursuant to the cancelled FIRST WIDGET AGREEMENT
and their rights under the $1.00 purchase option, and thus Plaintiffs are entitled to an award of
exemplary damages.
WHEREFORE, Plaintiffs pray judgment against defendants, and each of them, as follows:
1. For general damages according to proof;
2. For special damages according to proof;
3. For punitive damages;
4. For costs of suit incurred herein; and
5. For such other and further relief as the Court may deem proper.
DATED: , 2005

BY:_{——————}
Jane Wu, Esq.
Wu Law Firm
100 Main Street
Encino, CA 90231
Attorneys for Plaintiffs, ABC CORPORATION
and A, an individual

PROOF OF SERVICE

```
STATE OF CALIFORNIA, COUNTY OF LOS ANGELES
    I am employed in the County of Los Angeles, State of California. I am over the age of 18
and not a party to the within action; my business address is
    On 2005, I served the document described as:
```

COMPLAINT

on the interested parties in this action.
[X] by placing [ ] the original [X] a true copy thereof enclosed in a sealed envelope addressed as
follows:
[X] (BY MAIL)
[X] As follows: I am “readily familiar” with the firm's practice of collection and
processing correspondence for mailing. Under that practice it would be deposited with U.S.
postal service on that same day with postage thereon fully prepaid at Los Angeles, California, in
the ordinary course of business. I am aware that on motion ofthe party served, service is
presumed invalid if postal cancellation date or postage meter date is more than one day after date
of deposit for mailing in affidavit.
Executed on 2005 at Los Angeles, California.
[X] (STATE) I declare under penalty of perjury under the laws of the State of California that
the above is true and correct.
Signature_{——————}
Print Name_{——————}

TABLE 21
Jane Wu, Esq.
Wu Law Firm
100 Main Street
Encino, CA 90231

SUPERIOR COURT OF THE STATE OF CALIFORNIA, COUNTY OF LOS ANGELES

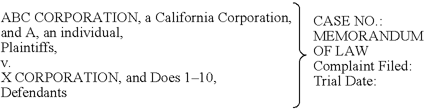

LEGAL MEMORANDUM

```
    Defamation includes libel and slander. Cal. Civil Code section 44. Libel is a false and
unprivileged publication by writing, printing, picture, effigy or other fixed representation to the
eye, which exposes any person to hatred, contempt, ridicule or obloquy, or which causes her to
be shunned or avoided, or which has a tendency to injure her in her occupation. Cal. Civil Code
section 45. Slander is a false and unprivileged publication, orally uttered, and also
communications by radio or any mechanical or other means which: 1. charges any person with
crime, or with having been indicted, convicted, or punished for crime; 2. imputes in her the
present existence of an infectious, contagious or loathsome disease; 3. tends to directiy injure her
in respect to her office, profession, trade or business, either by imputing to her general
disqualification in those respects which the office or other occupation peculiarly requires, or by
imputing something with reference to her office, profession, trade or business that has a natural
tendency to lessen her profits; 4. imputes to her frigidity or a want of chastity; or 5. which by
nature, causes actual damage. Cal. Civil Code section 46.
    There is a qualified privilege for entities reporting information about a consumer to a
credit agency; a legal action must establish false information furnished with malice or willful
intent to injure the consumer. C.C. 1785.32
    In this case, Defendants willfully defamed Plaintiffs by reporting a non-existent debt to
the credit reporting agencies, that resulted in adverse economic consequences to Plaintiffs
business.
DATED: , 2005
```

BY:_{——————}
Jane Wu, Esq.
Wu Law Firm
100 Main Street
Encino, CA 90231
Attorneys for Plaintiffs, ABC CORPORATION
and A, an individual

TABLE 22
Jane Wu, Esq.
Wu Law Finn
100 Main Street
Encino, CA 90231

SUPERIOR COURT OF THE STATE OF CALIFORNIA, COUNTY OF LOS ANGELES

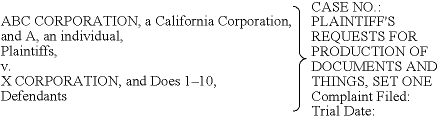

| | |
|---|---|
| Propounding Party: | PLAINTIFFS ABC CORPORATION and A, an individual |
| Responding Party: | DEFENDANT, X CORPORATION |
| Set No.: | One |

```
    Demand is hereby made pursuant to Code of Civil Procedure §2031 that you produce and
permit inspection and copying of the documents described below. The place for inspection shall
be at PLACE . The time for such inspection shall be DATE at 9:00 a.m.
    The term “Documents” as used herein means handwriting, typewriting, printing,
photostating, photographing, and every other means of recording upon any tangible thing any
form of communication or representation, including letters, words, pictures, sounds or symbols,
or combinations thereof, as set forth in Evidence Code §250.
```

REQUESTS FOR PRODUCTION

```
Request for Production No. 1:
    Defendants entire file, excluding attorney/client protected communications or work
product, pertaining to X CORPORATIONS purchase, sale, lease, use or other disposition of the
widgets subject to lease #5322DG396-1 (“the FIRST WIDGET AGREEMENT”), and lease
#584DG396-1 (“the WIDGET AGREEMENT”) including but not limited to the following:
    a. All correspondence with the manufacturer, distributor, vendor or any other
person, firm or entity relating to the widgets, including but not limited to XYZ
MANUFACTURING;
    b. All checks issued by X CORPORATION or any other person, firm or entity
under its direction or control to any manufacturer, distributor or vendor of the widgets;
    c. Copies of all checks or drafts from the manufacturer, distributor, vendor or any
other person, firm or entity, relating to the widgets, payable to X CORPORATION to any other
person, firm or entity or to its assignee;
    d. Bank records reflecting payments made to any manufacturer, distributor,
vendor or any person, firm or entity relating to the widgets;
    e. Bank records reflecting deposit of any monies received from any
manufacturer, distributor, vendor or any person, firm or entity relating to the widgets, and
    f. All notes or memoranda relating to such transaction.
Request for Production No. 2:
    All correspondence between X CORPORATION or any of its assignees with any credit
reporting agency(ies) with respect to ABC CORPORATION and/or A.
Request for Production No. 3:
    All correspondence between X CORPORATION or any of its assignees with anyone
regarding ABC CORPORATION and/or A.
Request for Production No. 4:
    Copies of any complaints or cross complaints filed against X CORPORATION, its
principals or any of its assignees relating to X CORPORATIONS credit reporting practices for
the years 1999, 2000, 2001, 2002 to the present.
Request for Production No. 6:
    Complete copies of the FIRST WIDGET AGREEMENT and the WIDGET
AGREEMENT.
Request for Production No. 7:
    Records of all payments made by ABC CORPORATION and/or A in connection with
THE FIRST WIDGET AGREEMENT.
Request for Production No. 8:
    Records of all payments made by ABC CORPORATION and/or A in connection with
THE WIDGET AGREEMENT.
Request for Production No. 9:
    Records of any action taken by any regulatory agency against X CORPORATION
relating to complaints made against X CORPORATION, its principals or any related entity for
the years 1999 to the present.
DATED: , 2005
```

BY:_{——————}
Jane Wu, Esq.
Wu Law Firm
100 Main Street
Encino, CA 90231
Attorneys for Plaintiffs, ABC CORPORATION
and A, an individual

TABLE 23
Jane Wu, Esq.
Wu Law Firm
100 Main Street
Encino, CA 90231

SUPERIOR COURT OF THE STATE OF CALIFORNIA, COUNTY OF LOS ANGELES

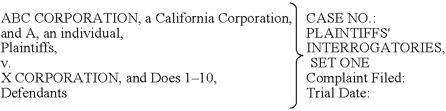

| | |
|---|---|
| Propounding Party: | PLAINTIFF ABC CORPORATION AND A, AN INDIVIDUAL |
| Responding Party: | DEFENDANT X CORPORATION |
| Set No.: | One |

Plaintiff ABC Corporation and A, an individual, hereby requests that Defendant, X
Corporation, answer under oath, pursuant to California Code of Civil Procedure §2030, the
following Interrogatories.

INTERROGATORIES

```
Interrogatory No. 0:
    State the full name, address and telephone number of the party preparing the Response to
these Interrogatories, and for each interrogatory, state from where or from whom the information
used to prepare the Response was obtained.
Interrogatory No. 1:
    Has any person, firm or entity filed suit against you for a violation of the Fair Debt
Collection Practices Act between DATE and the present?
Interroaatory No. 2:
If your answer to the preceding interrogatory is in the affirmative state the following:
  a. The name, address and telephone number of the plaintiff or cross complainant;
  b. The court caption, title and case number;
  c. The name, address and telephone number of counsel representing the plaintiff
or cross complainant; and
  d. The disposition of the action.
Interrogatory No. 3:
Has any person, firm or entity threatened action against you for a violation of the Fair
Debt Collection Practices Act between DATE and the present?
Interrogatory No. 4:
If your answer to the preceding interrogatory is in the affirmative state the following:
  a. The name, address and telephone number of the person, firm or entity who
threatened you;
  b. The basis for the threat, i.e the specific acts complained of; and
  c. The disposition of the matter.
Interrogatory No. 5:
Do you contend that Plaintiff breached the terms of the WIDGET AGREEMENT?
Interrogatory No. 6:
If your answer to the preceding interrogatory is in the affirmative state the following:
  a. The factual basis for your contention;
  b. The legal basis for your contention;
  c. The specific provision of the WIDGET AGREEMENT you contend was
breached by Plaintiff; and
  d. The date you contend Plaintiff breached such WIDGET AGREEMENT.
Interrogatory No. 7:
    Have you informed any credit reporting agency (ies) that Plaintiff has not complied with
any obligation required of it in accordance with the WIDGET AGREEMENT?
Interrogatory No. 8:
If your answer to the preceding interrogatory is in the affirmative, state the following:
  1. The name, address and telephone number of such credit reporting agency(ies);
  2. What information was provided by you to such credit reporting agency (ies);
  3. The date of such negative report; and
  4. The legal and factual basis for such negative report.
Interrogatory No. 9:
    State what investigation you conducted into this matter before you reported this negative
information to such credit reporting agency(ies).
Interrogatory No. 10:
    State the names, addresses and telephone numbers of all persons employed by you who
have knowledge or information about this matter.
DATED: , 2005
```

BY:_{——————}
Jane Wu, Esq.
Wu Law Firm
100 Main Street
Encino, CA 90231
Attorneys for Plaintiffs, ABC CORPORATION
and A, an individual

TABLE 24
Jane Wu, Esq.
Wu Law Firm
100 Main Street
Encino, CA 90231

SUPERIOR COURT OF THE STATE OF CALIFORNIA, COUNTY OF LOS ANGELES

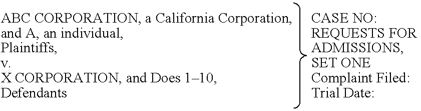

| | |
|---|---|
| Propounding Party: | PLAINTIFF ABC CORPORATION AND A, AN INDIVIDUAL |
| Responding Party: | DEFENDANT X CORPORATION |
| Set No.: | One |

Plaintiff ABC Corporation and A, an individual, hereby requests that Defendant, X
Corporation, admit or deny the truth of the following Requests for Admission pursuant to
California Code of Civil Procedure §2033, within 30 days of the date of service hereof.

DEFINITIONS

As used herein, the terms set forth below are defined as follows:
1. The term “X” refers to X Corporation, its agents, employees and representatives.
2. The term “WIDGET AGREEMENT” refers to the contract signed by Plaintiff and X for
the lease of 500 widgets by X to Plaintiff, dated March 10, 2003.

REQUESTS FOR ADMISSION

1. Admit that X communicated and provided negative credit information about Plaintiff to a
credit reporting agency.
2. Admit that the information provided to the credit reporting agency was that Plaintiff was
a collection account and owed money or some other obligation under the terms of the WIDGET
AGREEMENT.
3. Admit that the information provided to the credit reporting agency was inaccurate in that
Plaintiff did not owe any money or other obligation to X pursuant to the WIDGET
AGREEMENT.
4. Admit that X breached the WIDGET AGREEMENT.
5. Admit that as result of X's breach of the agreement, Plaintiff was excused
from any performance, including payment.
6. Admit that prior to the time such information was provided to the credit
reporting agency, X had not done an independent investigation to determine the status of any
alleged obligation under the WIDGET AGREEMENT.
7. Admit that it is X's custom and practice to report negative information about its customers
to credit reporting agencies without conducting an adequate investigation into the accuracy of the
facts which are used to support the allegation.
8. Admit that it is X's custom and practice to offer to persons such as Plaintiff
a proposal that in exchange for the payment of the alleged debt, X would
remove any negative credit information and would contact the credit reporting
agency to do so.
7. Admit that X communicated negative information about Plaintiff to persons
or entities, other than credit reporting agencies.
8. Admit that the communication of such negative information had an
adverse economic effect on Plaintiff and Plaintiffs business.
9. Admit that as a result of the communicating of such negative information,
Plaintiff suffered personal injury in the form of emotional pain and suffering
DATED: , 2005

BY:_{——————}
Jane Wu, Esq.
Wu Law Firm
100 Main Street
Encino, CA 90231
Attorneys for Plaintiffs, ABC CORPORATION
and A, an individual

TABLE 25
Jane Wu, Esq.
Wu Law Firm
100 Main Street
Encino, CA 90231

SUPERIOR COURT OF THE STATE OF CALIFORNIA, COUNTY OF LOS ANGELES

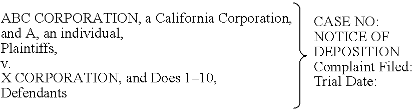

TO ALL PARTIES AND TO THEIR ATTORNEYS OF RECORD:

PLEASE TAKE NOTICE that on DATE at 11:00 a.m., Plaintiffs, ABC Corporation will
take the deposition of Uhrah Theef, CEO of X Corporation. The deposition will be taken
pursuant to Code of Civil Procedure §§2020 and 2025 before a certified shorthand reporter or
other officer duly authorized to administer oaths, at the offices of Jane Wu at 100 Main Street,
Encino, CA 90231. The deposition shall continue from day to day until completed,
Sundays and holidays excepted.
DATED: , 2005

BY:_{——————}
Jane Wu, Esq.
Wu Law Firm
100 Main Street
Encino, CA 90231
Attorneys for Plaintiffs, ABC CORPORATION
and A, an individual

TABLE 26
ABC CORPORATION and A v. X CORPORATION and Does 1-10
SUPERIOR COURT OF THE STATE OF CALIFORNIA,
COUNTY OF LOS ANGELES
DEPOSITION TOPICS FOR Uhrah Theef, CEO of X CORPORATION

1. Customs and practices of credit reporting.
2. Investigation into facts surrounding Plaintiff transaction with
X CORPORATION.
3. Communications with credit reporting agencies.
4. Communications with Plaintiffs.
5. Basis for claim of debt in the amount of $36,672.75, and
6. Basis for claim in letter to Plaintiffs that Plaintiffs owed $8,963.07.

Another embodiment of the present invention will now be described.

In this embodiment, instead of the case descriptive elements being defined manually, they are defied by a computer analyzing the law.

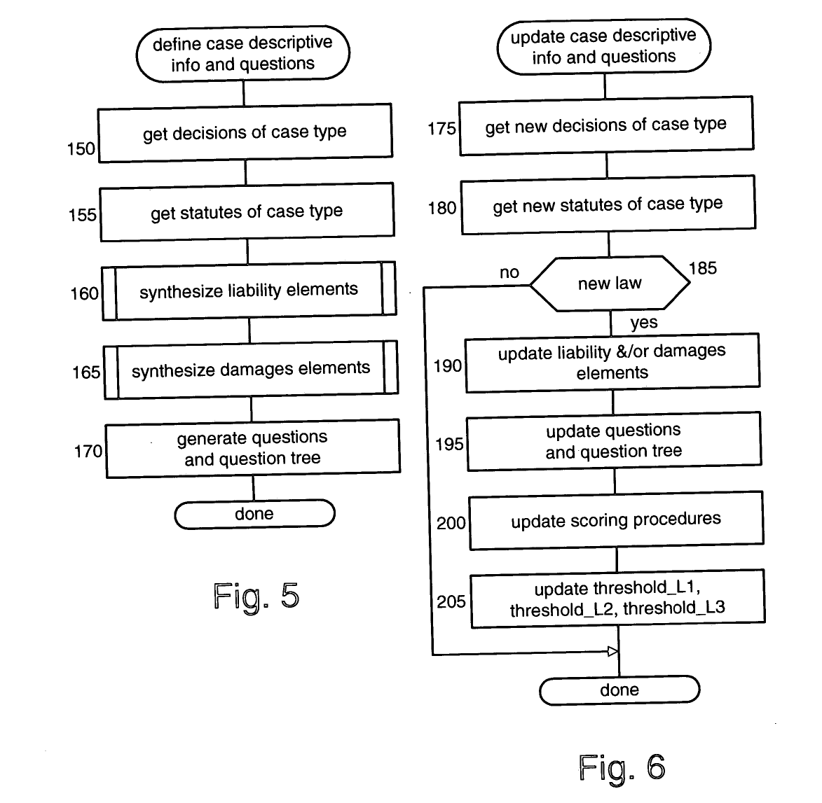

FIG. 5 corresponds to step 120 of FIG. 2, defining case descriptive information and questions.

At step 150, case evaluation system 72 obtains reported decisions for the selected case type, such as by downloading from a case reporter service such as Lexis or Westlaw. Preferably, these decisions have embedded metatags identifying the semantic meaning of the sentences of the decision. These metatags are explained at www.w3.org/2001/sw/ discussing the semantic web in which information is given well-defined meaning, better enabling computers and people to work in cooperation.

Historically, the major case reporting systems prepared so-called headnotes for each reported decision. The headnotes identify the outline section pertinent to the case, and contain short statements of the law presented in the case; usually, the headnotes use a common term for the substantive principles even if the term is not present in the decision. A legal researcher could then start with the case reporting system's outline to find relevant cases. Eventually, the case reporters put their reported decisions in computer-searchable form, so the headnotes became less important as a method of finding cases.

The present system can use keywords alone to identify cases, however, metatags improve the quality of information understanding by system 72.

Examples of metatags in a portion of a reported decision are shown in Table 27. A metatag is indicated by carats: < >. In this syntax, a law statement includes law elements and law results, when the law elements are present, the law result is in force. In some cases, metatags are added to clarify the meaning of indefinite pronouns and the like.

TABLE 27
<law statement: begin> The law is clear that <law element: begin> where the attorney of record
contracts for stenographic services as the agent of his client <law element: end> and <law
element: begin> where the fact of his <meaning: his = attorney's> agency is known to the party
with whom he <meaning: he = attorney> contracts <law element: end>, <law result: begin> the
attorney cannot be held responsible for the services in the absence of an undertaking to assume
such responsibility <meaning: responsibility = responsible for the stenographic services> <law
result:end>. (Bonynge v Field, 81 NY 159; see also, Matter of May, 27 NY2d 529.) <law
statement: end> Plaintiff's president states that plaintiff was not instructed to bill defendant's
client for the services it rendered and therefore billed defendant and that, when he made demands
for payment, he was “always told that the bill would be taken care of but it may be a slow pay.”
We think this presents a question of fact as to whether the attorney undertook to assume
responsibility for payment of plaintiff's services.

At step 155, system 72 obtains statutes for the selected case type, such as by downloading from Lexis, Westlaw, FindLaw or similar online service. Preferably, the statutes also have embedded metatags, as described above. Generally, reported decisions, also known as case law, state laws in the form “if (antecedent conditions) then (result)”. It will be appreciated that this is precisely the form of an inference rule used in so-called knowledge-based systems.

At step 160, system 72 synthesizes liability elements from the decisions and statutes. When metatags are present, this is a fairly straightforward process. For the example of Table 27, for the law result of “attorney responsible for stenographic services”, the liability elements are “attorney of record contracts for stenographic services as the agent of his client” and “the fact of attorney's agency is known to the party with whom attorney contracts”.

At step 165, system 72 synthesizes damages elements from the decisions and statutes, in similar manner as was done for liability elements.

At step 170, questions pertaining to the liability and damages elements are generated and formed into a question tree, that is, grouped to provide more details where appropriate. For the example of Table 27, sample questions are, “Did attorney contract with a party for stenographic services?” and “Was the fact of attorney's agency known to the party with whom attorney contracted?”.

Since new decisions and new statutes, possibly representing new law, could appear at any time, FIG. 6 provides a procedure for updating the case descriptive information and questions. The procedure of FIG. 6 can be executed at periodic intervals, such as weekly, or prior to working with the law for a subject area.

At step 175, case evaluation system 72 obtains new reported decisions for the selected case type, such as by downloading from a case reporter service such as Lexis or Westlaw.

At step 180, system 72 obtains new statutes for the selected case type, such as by downloading from Lexis, Westlaw, FindLaw or similar online service.

At step 185, system 72 determines whether the new decisions or statutes contain new law, such as by comparing the elements identified by metatags in a new case with the elements already defined in storage 45.

If no new law is present, processing is complete.

If new law is present, at step 190, system 72 updates appropriate liability and/or damages elements.

At step 195, questions pertaining to the liability and damages elements are generated and the existing question tree is updated.

At step 200, the scoring procedure is updated to reflect the new liability and/or damages elements.

At step 205, the scoring thresholds for L1, L2, L3 are optionally updated.

Yet another embodiment of the present invention will now be described.

In this embodiment, when collecting information from the claimant, system 72 dynamically decides which questions to present to the claimant based on the claimant's responses to a set of predefined questions. Generally, this corresponds to how an attorney interviews a client: the attorney first asks what can I help you with, and then formulates more detailed questions in response to the information provided by the client.

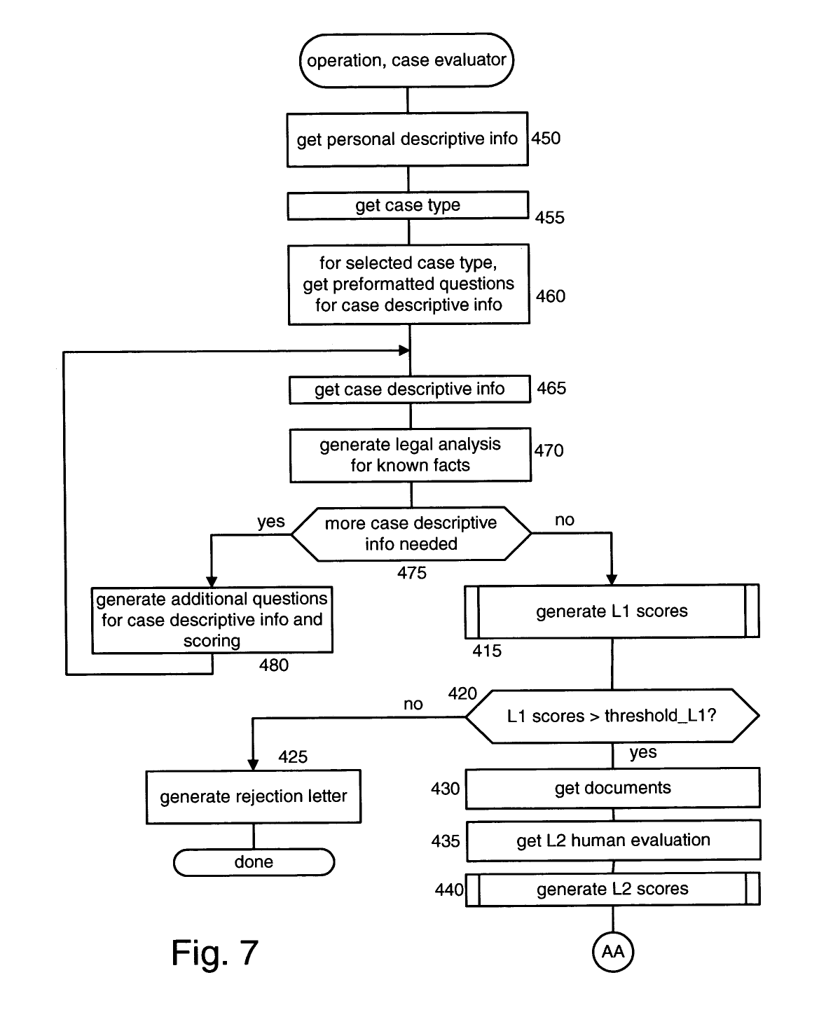

Turning to FIG. 7, steps 450, 455, 460 generally correspond to steps 400, 405, 410, of FIG. 3A, and are not discussed in detail for brevity.

At step 465, system 72 gets the case descriptive information requested by the preformatted case descriptive questions from the claimant.

At step 470, system 72 generates a legal analysis based on the known facts. Generally, this is accomplished by checking whether the information provided by the claimant satisfies any of the antecedent conditions of system 72's legal rules. When some but not all of the antecedent conditions are specified, the legal analysis is of the form “legal result” may be present here because “specified antecedent conditions”. When all antecedent conditions are specified, the legal analysis is similar, except states “is present” instead of “may be present”. Of course, it is necessary to determine whether defendant has defenses to the legal result.

At step 475, system 72 determines whether more case descriptive information is required. Generally, this is simply a matter of determining whether there are rules for which some, but not all, antecedent conditions for which information has not been specified. The additional case descriptive information corresponds to the antecedent conditions for which information is missing.

If more case descriptive information is required, at step 480, system 72 generates additional case descriptive information questions and scoring, and returns to step 465. The additional questions can be generated by retrieving from a list of stored questions, or from dynamically generating the question based on the antecedent condition lacking information.

When sufficient case descriptive information is provided, processing continues at step 415, which is the same processing as step 415 of FIG. 3A.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A method of deciding how to process a pre-litigation case, comprising:
receiving, at a computer, information about the case from a claimant,
determining, at the computer, a case score based on the received information,
comparing, at the computer, the case score with a predefined threshold, and
selecting, at the computer, further processing for the case based on the comparison.

2. The method of claim 1, wherein the case score is based on a liability score and a damages score.

3. The method of claim 2, wherein the liability score is obtained by:
for each liability element, determining an element score based on information provided by the claimant,
for each liability element, multiplying the element score by a predetermined element weight to generate an intermediate result, and
summing the intermediate results for all of the liability elements to produce the liability score.

4. The method of claim 2, wherein the damages score is obtained by:
for each damages element, determining an element score based on information provided by the claimant,
for each damages element, multiplying the element score by a predetermined element weight to generate an intermediate result, and
summing the intermediate results for all of the damages elements to produce the damages score.

5. The method of claim 1, wherein the further processing comprises determining what additional information should be collected from the claimant.

6. The method of claim 5, further comprising adjusting the case score based on the additional information collected from the claimant.

7. The method of claim 1, wherein the further processing comprises determining what documents should be collected from the claimant.

8. The method of claim 7, further comprising adjusting the case score based on the documents collected from the claimant.

9. The method of claim 1, wherein the further processing comprises interviewing the claimant.

10. The method of claim 9, further comprising adjusting the case score based on the interview with the claimant.

11. The method of claim 1, wherein the further processing comprises rejecting the case.

12. The method of claim 1, wherein the further processing comprises referring the case to an outside attorney.

13. The method of claim 1, wherein the further processing comprises accepting the case.

14. The method of claim 1, wherein the received information includes a case type, and further comprising preparing documents based on the received information and predetermined information associated with the case type.

15. The method of claim 14, wherein the prepared documents include a Complaint.

16. The method of claim 14, wherein the prepared documents include a discovery request.

17. The method of claim 14, wherein the prepared documents include a budget and schedule for the case.

18. The method of claim 1, further comprising eliciting, at the computer, the information about the case from the claimant, and wherein the information is predetermined using automated analysis of reported legal decisions.

19. The method of claim 1, further comprising eliciting, at the computer, the information about the case from the claimant, and wherein the information is predetermined using manual analysis of reported legal decisions.

20. The method of claim 1, further comprising
detecting, at the computer, the existence of missing information, and
presenting, from the computer, a question to the claimant to elicit the missing information.

21. A system for deciding how to process a pre-litigation case, comprising:
a communications interface for receiving information about the case from a claimant, and
at least one processor for determining a case score based on the received information, comparing the case score with a predefined threshold, and selecting further processing for the case based on the comparison.
